(19) United States
(12) Patent Application Publication
(10) Pub. No.: US 2003/0035539 A1
(43) Pub. Date: Feb. 20, 2003

(54) System and method for distributing secure documents

(76) Inventor: Daniel D. Thaxton, New Lebanon, OH (US)

Correspondence Address: Killworth, Gottman, Hagan & Schaeff, L.L.P., Suite 500, One Dayton Centre, Dayton, OH, 45402-2023, US

(21) Appl. No.: 09/932,158

(22) Filed: Aug. 17, 2001

(51) Int. Cl. H04L 9/00

(52) U.S. Cl. 380/51

(57) ABSTRACT

The present invention is drawn to system and method for securely distributing secure documents over a network such that an intended recipient can print the secure document data using a home or office desktop printer. The secure document is printed on a specialty paper that includes integral therewith, a first authenticating code. The first authenticating code may be derived from any practical identification technology such as RFID. To generate a secure document, an appropriate detector is integrated into a desktop printing platform. The detector reads the first authenticating code from the specialty paper, which is communicated to a first transaction processor. The first transaction processor provides a second authenticating code and any other secure document data pertinent to the transaction, which is communicated back to the requestor of the secure document and printed on the specialty paper.

### BACKGROUND OF THE INVENTION

The present invention relates in general to secure documents and in particular to a system and method for electronically distributing and validating secure documents.

Paper based, secure documents are vulnerable to fraudulent activities including tampering, altering and counterfeiting. Counterfeiting activities are facilitated in large part by the ready availability of copier technology, which may be used to copy or scan legitimate documents. For example, using available copier technology, it is possible to extract bank data, account data, and personal data including signatures from legitimate documents. Unfortunately, fraudulent activity can be difficult to detect. In fact, often times a fraudulent document appears genuine to a person inspecting the document, especially when the person inspecting the document is improperly trained in detecting fraud or has insufficient time to inspect the document properly. Despite these vulnerabilities, paper based, secure documents are widely popular because such documents provide a high degree of portability and acceptance.

As an alternative to paper based documents, certain types of secure documents, typically negotiable instruments, are available electronically. The current strategy for electronic delivery of such a document entails delivering data representing the secure document over a computer network connection, such as the Internet. As a security measure, a unique code is assigned to the transaction and delivered with the secure document data. The unique code is intended to be difficult to compromise and may include for example, encrypted identification numbers. The unique code is used at the point of acceptance to validate the authenticity of the instrument.

However, vulnerability to fraud also exists where a secure document is electronically delivered to a recipient. For example, fraudulent instruments may be created by the unauthorized duplication of the electronic data delivered to the recipient of the secure document. This may be accomplished either by intercepting the electronic transmission from the issuer to the intended recipient, or by accessing the data directly from the location where the intended recipient is storing the data. Despite these opportunities for fraud, delivery of secure documents electronically is gaining popularity. The speed at which modern networks operate, combined with the automated processes typically employed to drive such transactions results in a high degree of flexibility and convenience not available with paper based secure documents.

Accordingly, there is a need for a scheme for providing secure documents that combines the conveniences and speed offered by electronic delivery, with the portability and acceptance of paper based secure documents, and further includes built in protections that eliminate or at least greatly reduce the chances of fraud.

### SUMMARY OF THE INVENTION

The present invention overcomes the disadvantages of previously known systems and methods for generating secure documents by providing a system and method for securely distributing secure documents remotely over a network such that an intended recipient can print the data using a home or office desktop printer to generate an authentic, secure document.

A secure document is printed on a specialty paper and includes two distinct authentication codes. The first authentication code is a unique code contained with the specialty paper itself and may be derived from any practical identification (ID) technology. The second authentication code is a unique code assigned by the issuer and is printed onto the face of the specialty paper in the course of the transaction.

To generate a secure document, an appropriate detector is integrated into a desktop printing platform, or alternatively, is arranged to attach easily to an existing printer. The detector must be capable of reading the first authenticating code, which is contained with the specialty paper. The specialty paper is loaded into the printer and a communication link is established with a first transaction processor. The first transaction processor is associated with the issuer, and processes requests for secure documents. The first authenticating code is read from the specialty paper by the detector, and communicated to the first transaction processor, for example, using the Internet. The first transaction processor provides a second authenticating code and any other secure document data pertinent to the transaction, which is communicated back to the requester of the secure document. The first transaction processor also links and stores the first and second authenticating codes in a database of valid authenticating codes. The secure document data, including the second authenticating code are then printed on the specialty paper to complete the creation of a legitimate secure document.

When the secure document is presented in order to redeem it's value, a second transaction processor reads both the first and second authenticating codes using suitable readers. The first and second authenticating codes are communicated to a third transaction processor. The third transaction processor compares the first and second authenticating codes to the database of valid authenticating codes. If the first and second authenticating codes are located in the database, the transaction is authorized, and the secure document is honored. Otherwise, the secure document is considered invalid and may be dishonored.

In addition, the present invention is useful in any application where there exists a desire to match a uniquely identified document with data issued from a central or common location. The present invention is particularly suited for applications where the document is issued and authenticated using automated processes.

Accordingly, it is an object of the present invention to provide a system and method for distributing secure documents that provides a means to authenticate and validate the secure document.

It is an object of the present invention to provide a system and method for distributing secure documents that prevents fraudulent activities derived from inappropriately obtaining the secure document data in electronic form.

It is further an object of the present invention to provide a system and method for distributing secure documents that prevents fraudulent activities derived from inappropriately tampering with, altering, or counterfeiting an authentic printed version of the secure document.

It is still further an object of the present invention to provide a system and method that provide a means to authenticate and validate a printed document having secure data thereon.

Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is an illustration of a specialty paper used to print a secure document according to one embodiment of the present invention;

FIG. 2 is an illustration of a secure document printed on the specialty paper illustrated in FIG. 1;

FIG. 3 is a schematic flow diagram illustrating a system for generating secure documents according to one embodiment of the present invention;

FIG. 4 is a schematic diagram illustrating a system for validating secure documents according to one embodiment of the present invention; and,

FIG. 5 is a schematic diagram illustrating a system for generating and validating secure documents according to one embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

### THE SPECIALTY PAPER

The present invention relates to a system for distributing documents, and is especially suited for distributing secure documents. As used herein, the term “secure document” generally refers to any document or token of any kind that contains important information, or sensitive information, or that has value. Some examples of secure documents include checks, traveler checks, event tickets, stamps, gift certificates or cards, passports, titles, registrations, bearer instruments, negotiable instruments, government records, stock certificates, deeds, transcripts, coupons, and receipts.

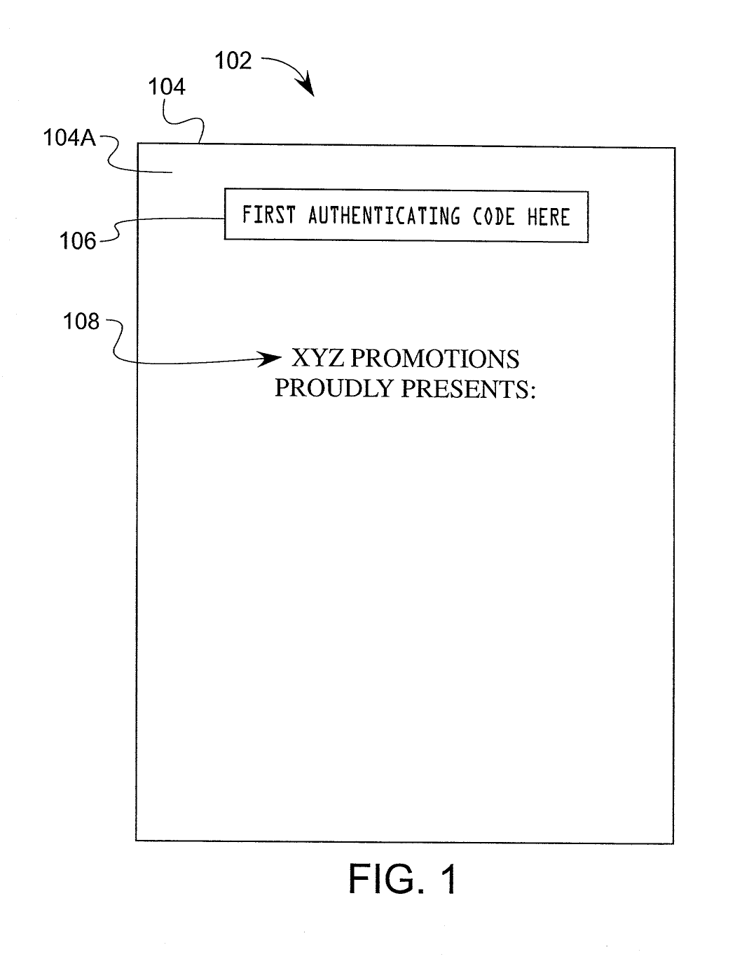

Secure documents according to the present invention are printed on a specialty paper. Referring to FIG. 1, an example of one type of specialty paper 102 for use as an event ticket is illustrated. The specialty paper 102 comprises a printable media 104. The printable media 104 may be any material suitable for printing as is known in the art. The selection of the printable media 104 will depend upon numerous factors including the intended application, the types of printers used with the printable media 104, and the means used for authenticating the secure document, as more fully explained herein. The printable media 104 may comprise, for example, paper or cardboard paper stock, including paper suitable for use as a label.

The specialty paper 102 further includes a unique first authenticating code 106 integral therewith. By integral therewith, it is meant that the first authenticating code 106 is required to be present with the printable media 104. The first authenticating code 106 may be embedded within the printable media 104, attached thereto, or printed thereon, as more fully explained herein. The first authenticating code 106 can be any type of code intended to identify uniquely, the particular specialty paper 102. As such, each specialty paper 102 for a given application has a unique first authenticating code 106. For example, the first authenticating code 106 may comprise a simple numbering scheme, or may comprise any combination of alphanumeric or other symbols.

The first authenticating code 106 is preferably provided in a machine-readable format. For example, the first authenticating code 106 may comprise a radio frequency identification device (RFID), magnetic ink character recognition (MICR) indicia, optical character recognition (OCR) indicia, bar codes, encrypted bar codes, or indicia printed in invisible inks on the front face 104A or the back face (not shown) of the printable media. The above list is not inclusive; rather any machine-readable identification technology may be used to implement the first authenticating code 106.

In one embodiment of the present invention, an RFID device is programmed to store a uniquely assigned first authenticating code 106. RFID technology does not depend upon optical, or line of sight readers. This allows the RFID device to be secured on either the front or back face of the specialty paper 102, or preferably, the RFID device may be embedded into the specialty paper 102. In another embodiment of the present invention, the first authenticating code 106 comprises a magnetic stripe permanently affixed to the specialty paper 102.

In yet another embodiment, the first authenticating code is printed on the front face 104A of the printable media 104 using invisible inks or photo luminescent inks, such as those provided by PhotoSecure, Inc. of Boston Massachusetts. The invisible ink may comprise any ink or dye platforms that include covert, unique spectral signatures. For example, one invisible ink provided by PhotoSecure inc. incorporates unique photo luminescent properties of converting phosphors that can be read using a hand held reader.

As shown in FIG. 1, the first authenticating code 106 is generally centered, near the top portion of the printable media 104. This positioning is merely exemplary of one possible arrangement. The exact positioning of the first authenticating code 106 with respect to the printable media 104 will depend upon the intended application and the type of reader used to read the first authenticating code 106. For example, bar, MICR, and OCR codes may be printed in any position on the printable media 104, but are typically printed in one or more lines adjacent to one edge of the printable media 104. MICR codes are typically printed left justified, near the bottom edge (not shown). Likewise, magnetic stripe or RFID tags may be applied to either the face 104A or the back (not shown) of the printable media 104 in any position. Further, an RFID tag may be imbedded in the material that comprises the printable media 104. Under this arrangement, the RFID tag may be visible through the printable media 104 or, alternatively, the RFID tag may be not readily discernable through the printable media 104.

Depending upon the application and the requirements of the specific issuer, the specialty paper 102 may optionally include preprinted indicia 108. For example, as more fully explained herein, a requestor may have a relatively simple printer with limited printing capabilities, and yet the issuer may wish the secure documents to be colorful or intricate. Therefore, the preprinted indicia 108 may comprise color graphics, special logos, insignias, or any other indicia that may be beyond the printing capabilities of a typical ink jet or laser jet printer. The specialty paper 102 may likewise be completely blank and include therewith only the first authenticating code 106.

### THE SECURE DOCUMENT

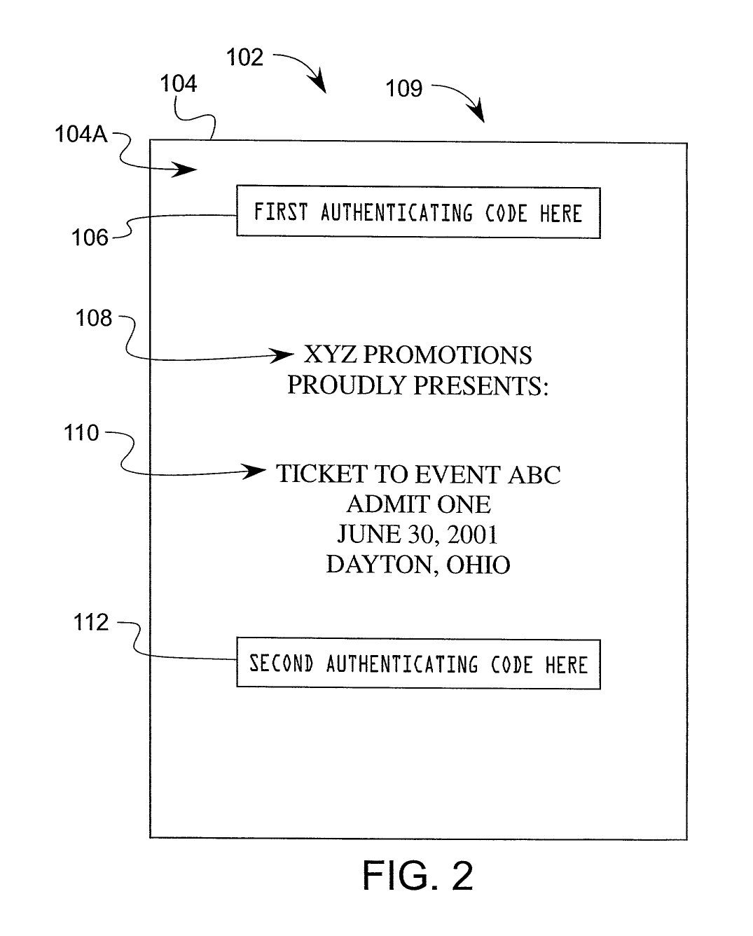

FIG. 2 shows an example of a secure document 109, an event ticket as illustrated. The secure document 109 was printed on the specialty paper 102 discussed with reference to FIG. 1. As such, like structure is indicated with like reference numerals.

The secure document 109 includes additional indicia 110. The indicia 110 may include any combination of text and graphics. However, it will be appreciated that the nature of the additional indicia 110 is dependent upon the capabilities of the printer of the requester of the secure document 109. For example, a black and white printer is incapable of printing a color graphic. Additional indicia 110 may therefore be printed in black and white on a black and white printer, and in color on a color printer if desired. The indicia 110 will vary depending upon the type of secure document 109 issued, but may include for example, the value of the secure document 109, the dates upon which the secure document is valid for redemption, the locations where the secure document is redeemable, and any other data pertinent to the secure document 109.

The secure document 109 additionally includes a second authenticating code 112. Although shown at the bottom portion of the specialty paper 102, the second authenticating code 112 may be positioned anywhere on the printable media 104, as the application dictates. The second authenticating code 112 is generated by the issuer and is delivered to the intended recipient in response to a transaction to obtain a secure document 109, as more fully explained herein. The second authenticating code 112 may be any combination of alphanumeric indicia or graphics. However, the code used to represent the second authenticating code 112 is limited by the capabilities of the printer that prints the secure document 109. The second authenticating code 112 is preferably printed in a machine-readable format. For example, OCR codes, bar codes, and encrypted bar codes are preferable formats for representing the second authenticating code 112 on the secure document 109, although any format may be used.

### SYSTEM FOR DISTRIBUTING SECURE DOCUMENTS

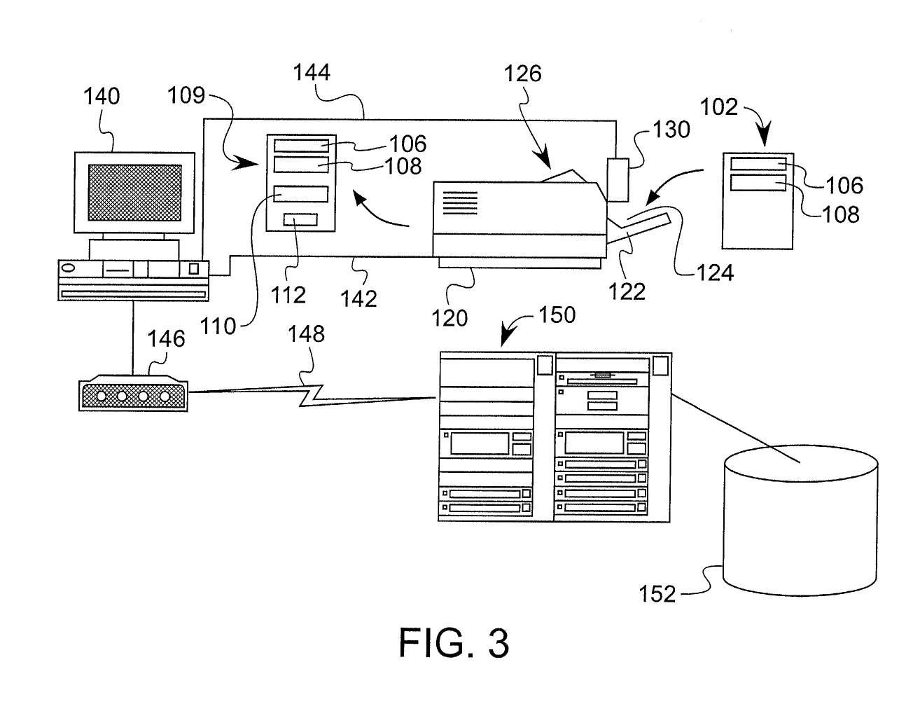

Referring to FIG. 3, the flow of a typical transaction according to one embodiment of the present invention is schematically illustrated. Initially, the specialty paper 102 is loaded into a desktop printing system or printer 120 such as a laser jet or ink jet printer. For example, the specialty paper 102 is inserted into the input tray 122 of the printer 120. The orientation of the specialty paper 102 in the input tray 122 will depend upon the specifics of the printer 120.

The printer 120 includes a detector 130 arranged to read the first authenticating code 106 from the specialty paper 102. The type of detector 130 selected, and the positioning of the detector 130 with respect to the printer 120 will vary depending upon the type of identifying technology used. For example, if the first authenticating code 106 is programmed into an RFID device, then the detector 130 need not optically be within the line of sight of the first authenticating code 106. Where the first authenticating code is a bar code, encrypted bar code, MICR indicia, or OCR indicia, then the detector 130 must be positioned appropriately for reading the first authenticating code 106. For example, the detector 130 may be positioned along a paper feed path 124 of the printer. The paper feed path 124 includes the path of travel of the paper 102 from the input tray 122 to the output tray 126, including paper travel internal and external to the printer 120. Alternatively, the detector 130 may optionally comprise a hand-held scanner. This may be particularly advantageous where the first authenticating code 106 is implemented using invisible ink or other ink based covert signatures.

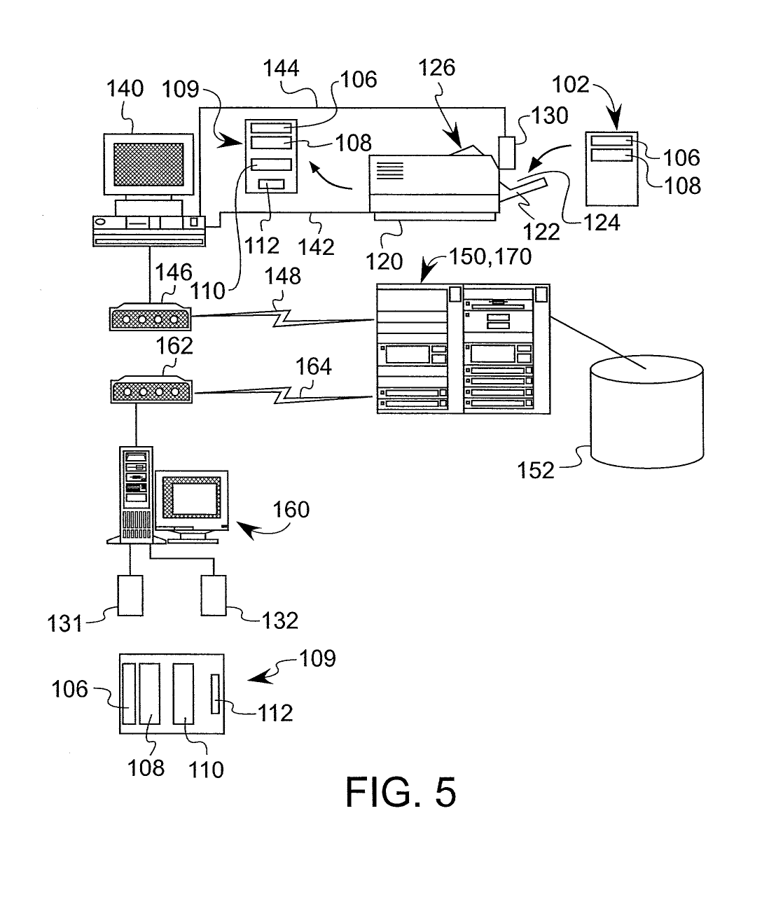

As illustrated in FIGS. 3 and 5, the detector 130 is mounted to the printer 120 near the input tray 122. However, it shall be appreciated that the exact positioning of the detector 130 can vary. For example, the detector 130 may be integrated into the printer 120 or alternatively, the detector 130 may be attached to the printer 120 as a separate unit, for example, such as along the paper feed path. Preferably, the detector 130 comprises an inexpensive device that easily adapts to the printer 120. Alternatively, the detector 130 may comprise a hand held scanner or other device that is not attached directly to the printer 120.

The printer 120 is connected to a computer 140 through interface 142. The computer 140 can be any general-purpose home or office computer. The interface 142 may utilize any technology as is known in the art. For example, the interface 142 may comprise a direct cable connection between the computer 140 and the printer 120, or the computer 140 may be coupled to the printer 120 through a network connection. As such, the printer 120 need not reside in the same physical location as the computer 140. Alternatively, the computer 140 as a separate unit may not be required. For example, the detector 130 may be a smart appliance or otherwise contain a processor suitable for carrying out the necessary transactions, having a built in communication interface. Further, the computer and printer may be integrated into a kiosk or other turnkey system.

As illustrated, however, the detector 130 communicates with the computer 140 via the first communication link 144. The first communication link 144 is illustrated schematically as a direct connection, but it will be appreciated that any appropriate arrangement may be used to establish communication between the detector 130 and the computer 140. For example, the printer 120 and the detector 130 may share a common connection to the computer 140, or communication may be established through a network connection. Further, no communication link is necessary if the detector 130 includes circuitry capable of handling the necessary transactions, since a computer is not required with such an arrangement.

As shown in FIG. 3, the computer 140 communicates with a first transaction processor 150 via a communications device 146, establishing a second communication link 148. While schematically illustrated as a modem communicating across a network connection, it will be appreciated that the communications device 146 and the second communication link 148 may be replaced with any technology available in the art that allows the first authenticating code 106 to be communicated to the first transaction processor 150. For example, any combination of modems, routers, network interfaces, or other communications devices may be used to form a connection to the first transaction processor 150 using any network such as the Internet, local area networks, wide area networks, intranets, extranets, or direct connections.

The first transaction processor 150 may be any processor arranged to process requests for secure documents. The first transaction processor 150 is associated with the issuer of the secure document and is arranged such that automated transactions, preferably from a central location, may be carried out. According to one embodiment of the present invention, the first transaction processor 150 resides on the issuer's computer system. For example, where the second communication link 148 comprises an Internet connection, the first transaction processor 150 may comprise World Wide Web enabled software application(s) and any associated hardware required by the software. For example, the first transaction processor 150 includes a storage means, such as a data repository 152, capable of storing data relevant to the issuance of p secure documents 102.

According to one embodiment of the present invention, a small RFID device, such as the Hitachi uChip, is embedded in the paper 102. The first authenticating code 106 comprises a unique number that is stored in the RFID device. The first authenticating code 106 is easily read by the detector 130, which is attached to the printer 120 in proximity to the paper feed path 124 and adjacent to the paper input tray 122. The computer 140 includes a printer driver (not shown) that activates reading and uploading of the first authenticating code 106 from the printer 120 to a website where the first transaction processor 150 resides. In other embodiments, the computer 140 may run proprietary software or, alternatively, require only a web browser to communicate with the first transaction processor 150.

### ISSUING A SECURE DOCUMENT

A supply of specialty paper 102 is obtained from an issuer prior to initiating a transaction with an issuer. The manner in which the specialty paper is obtained will vary depending upon the preference of the issuer. For example, the issuer of the secure document 109 may provide the specialty paper directly to customers or to branches or offices within the issuer's business. Alternatively, the recipient may purchase the specialty paper from a retail establishment, such as an office supply store, a specialty paper supplier, via a stationer, or any provider of cut sheet papers.

The intended recipient loads the specialty paper 102 into the printer 120 and establishes communication with the first transaction processor 150. In the course of the transaction, the first transaction processor 150 receives the first authenticating code 106. For example, the computer 140 may communicate with the detector 130 to obtain the first authenticating code 106, and then upload the first authenticating code 106 to the first transaction processor 150. Alternatively, once a communication link is established between the computer 140 and the first transaction processor 150, the first transaction processor 150 may read the data directly from either the computer 140 or from the detector 130.

The first transaction processor 150 accepts the unique, first authenticating code 106 and any additional information required to conduct the transaction. The first transaction processor 150 also generates the data required for the type of secure document 109 requested. The first transaction processor 150 communicates back to the computer 140, the secure document data including optional indicia 110, and the second authenticating code 112. The second authenticating code 112 represents a code unique to the transaction initiated. The first transaction processor 150 also stores the first and second authenticating codes 106,112 in the data repository 152 for authentication and verification at the time of presentment of the secure document 109, as more fully explained herein.

Finally, the optional indicia 110 and the second authenticating code 112 are transmitted from the computer 140 to the printer 120, and are printed onto the printable media 104, defining a complete secure document 109. It shall be observed that the optional indicia may be transmitted as an image file, or as individual data, so long as the printer 120 places the optional indicia 110 properly on the printable media 104.

The interaction between the first transaction processor 150 and the computer 140 can vary widely depending upon the transaction. In one embodiment of the present invention, the first transaction processor 150 communicates with the first computer 140 throughout the process of creating and printing the secure document 109. The issuer is thus protected by false denial of service claims, that is, claims that the holder “forgot” to use the correct printable media when printing the secure document 109 because the first transaction processor 150 will not have closed the transaction (i.e., considered the secure document valid) until the unique paper identification (first authentication code 106) has been received by the issuer at the time of issuance. The first transaction processor 150 may optionally remain in communication with the computer 140 until the first transaction processor 150 receives verification that the second authenticating code 112 was successfully printed on the printable media 104 bearing the associated first authenticating code 106. Under this arrangement, should the printer 120 jam, run out of toner or ink, or otherwise print the secure document 109 with poor quality, corrective measures may be taken.

The first transaction processor 150 may optionally collect a payment or fee, or any data in the process of carrying out the transaction. Once payment has been received and the first transaction processor 150 has received sufficient information to process the transaction, the first transaction processor 150 instructs the first computer 140 to print the secure document 109, including the second authenticating code 112 and user variable indicia 110 on the printout of the secure document 109.

### AUTHENTICATING THE SECURE DOCUMENT

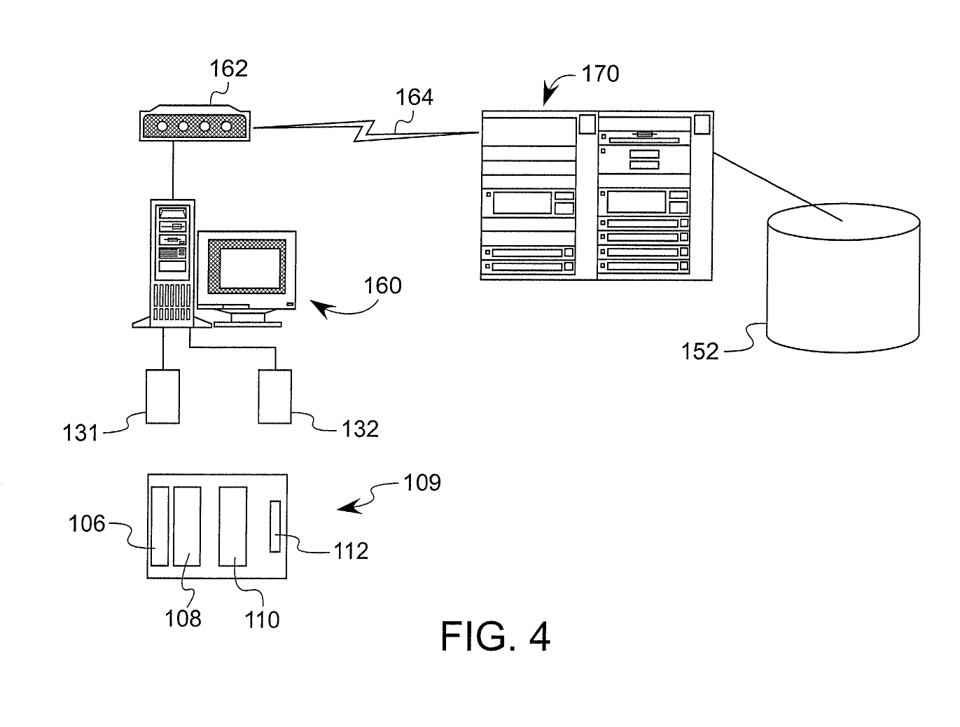

A system for validating the secure documents when they are presented to a second transaction processor 160 for redemption is schematically illustrated in FIGS. 4 and 5. The second transaction processor 160 comprises a communications device 162 and is capable of establishing a communications link 164 to a third transaction processor 170. The communications device 162 and communications link 164 may comprise any technology that allows the second transaction processor 160 to communicate with the third transaction processor 170, including those devices and connections discussed with reference to communications device 146 and second communications link 148 illustrated in FIGS. 3 and 5. To authenticate a secure document 109, a first reader 131 that is coupled to the second transaction processor 160 reads the first authenticating code 106. A second reader 132 that is coupled to the second transaction processor 160 reads the second authenticating code 112. Both the first and second authenticating codes 106, 112 are transmitted to a third transaction processor 170 via communications device 162 and communications link 164.

The second transaction processor 160 may be an automated machine or computer. Alternatively, the second transaction processor 160 may comprise a human operator and one or more devices. The first reader 131 is any suitable reader arranged to read the first authenticating code 106. Likewise, the second reader 132 is any reader arranged to read the second authenticating code 112. In the event that the first and second authenticating codes 106,112 are applied to the document 109 in the same manner, e.g., both the first and second authenticating codes 106,112 are bar code indicia, a single reader may be used for this purpose.

he third transaction processor 170 checks the data repository 152 to validate and to authenticate the transaction. A response is then provided to the second transaction processor 160 to indicate the results of the validation search. The second transaction processor 160 may then either honor or refuse to honor the secure document 109. For example, if both the first and second authenticating codes 106, 112 match a record in the data repository 152, then a message may be relayed to the second transaction processor 160 to honor the secure document 109. On the other hand, if the first and second authenticating documents 106, 112 do not match a record stored in the data repository 152, then a message may be generated to dishonor the secure document 109.

As illustrated in FIG. 5, the first and third transaction processors 150, 170 may be implemented on the same hardware, and/or within the same software. Alternatively, the first and third transaction processors 150, 170 may be implemented on separate hardware and/or software, as schematically illustrated in FIGS. 3 and 4, respectively, so long as the first transaction processor 150 has the ability to store valid authenticating codes, and the third transaction processor 170 has access to read those stored authenticating codes.

It will be appreciated that any of a variety of storage and validation routines may be used. For example, where the first and second authenticating codes 106, 112 are stored in a database, additional useful data may also be stored regarding the transaction. For example, the data repository 152 may also record the time, date, and location of the original transaction. User demographics and other valuable information may also be collected and stored. Further, fees or payments may be processed. Additionally, notes and memos may also be associated with a transaction record. For example, if a user reports a secure document 109 either lost or stolen, or if the user reports a paper jam or other printing failure, an appropriate message can be generated so that if the secure document 109 is presented, the second transaction processor 160 may be alerted to that fact.

The secure document 109 according to the present invention eliminates or greatly reduces the fraudulent copying of the secure document 109, and further avoids fraudulent activities directed toward the nefarious interception of data pertaining to the secure document 109 that has been transmitted over the communications links such as the Internet. For example, even if a fraudulent interception of the first and second authenticating codes 106, 112 is achieved, one would not be able to complete the fraudulent activity because the first authenticating code 106 is provided with the specialty paper 102. It is unlikely that a perpetrator would be able, for example, to program an RFID device and embed that RFID device into a printable media 104. In other words, even if the unique values of the first and second authenticating codes 106, 112 are known, a perpetrator must still be able to apply those codes to a printable media 104 such that the first authenticating code 106 is read by the first reader 131, and the second authenticating code 112 is readable by the second reader 132.

With the techniques taught by the present invention, common replication technologies cannot be used to reproduce the secure document 109, since the copy or replica will not carry the unique paper identification (first authentication code 106) known and recorded by the issuer via the first transaction processor 150.

Further, other possible uses for the present invention comprise an application where there exists a desire to match a uniquely identified token or instrument distributed remotely with data issued from a central or common location via an automated process. Such applications may include use by the Department of Motor Vehicles or any other source of distributed identification, titles, or licensing, phone or gift cards, stock certificates, deeds, titles, checks, transcripts, government records, coupons, and receipts.

Having described the invention in detail and by reference to preferred embodiments thereof, it will be apparent that modifications and variations are possible without departing from the scope of the invention defined in the appended claims.

What is claimed is:

1. A method of generating a secure document comprising:
reading a first authenticating code from a printable media;
communicating said first authenticating code to a first transaction processor;
receiving a second authenticating code from said first transaction processor; and,
printing said second authenticating code on said printable media.

2. A method of generating a secure document according to claim 1, wherein reading said first authenticating code comprises:
positioning a detector proximate to a printer;
placing said printable media in said printer; and
reading said first authenticating code from said printable media at said printer with said detector.

3. A method of generating a secure document according to claim 1, wherein reading said first authenticating code comprises:
obtaining a specialty paper, said specialty paper comprising said printable media and having therewith said first authenticating code; and,
inserting said printable media into a printer, said printer including a detector along a paper feed path of said printer, wherein said detector is arranged to read said first authenticating code from said printable media.

4. A method of generating a secure document according to claim 3, wherein said printer is further coupled to a computer, and communicating said first authenticating code comprises:
establishing a communications link between said computer and said first transaction processor.

5. A method of generating a secure document according to claim 4, further comprising:
using a printer driver on said computer to effect communications between said computer, said printer and said detector.

6. A method of generating a secure document according to claim 1, wherein reading said first authenticating code comprises coupling a detector to a computer such that a first communication link exists between said computer and said detector.

7. A method of generating a secure document according to claim 6, wherein communicating said first authenticating code comprises:
establishing a second communication link between said computer and said first transaction processor.

8. A method of generating a secure document according to claim 6, wherein communicating said first authenticating code comprises:
establishing a communication link using the Internet.

9. A method of generating a secure document according to claim 1, further comprising receiving user variable data from said first transaction processor and printing said user variable data onto said printable media.

10. A method of generating a secure document according to claim 1, wherein communicating said first authenticating code comprises communicating said first authenticating code to said first transaction processor before said first transaction processor returns said second authenticating code.

11. A method of receiving a secure document using a distributed network comprising:
obtaining a printable media, said printable media having therewith, a first authenticating code;
placing said printable media in a printer;
detecting said first authenticating code;
communicating said first authenticating code to a first transaction processor;
receiving a second authenticating code from said first transaction processor; and,
printing said second authenticating code on said printable media.

12. A method of receiving a secure document using a distributed network according to claim 11, wherein obtaining a printable media comprises obtaining a printable media having therewith, a radio frequency identification device that has been preprogrammed to store said first authenticating code.

13. A method of receiving a secure document using a distributed network according to claim 12, wherein detecting said first authenticating code comprises using a radio frequency identification reader to read said first authenticating code from said radio frequency identification device.

14. A method of receiving a secure document using a distributed network according to claim 13, wherein detecting said first authenticating code comprises positioning said radio frequency identification reader such that said first authenticating code is readable by said radio frequency identification reader when said printable media is in the paper path of said printer.

15. A method of receiving a secure document using a distributed network according to claim 12 wherein communicating said first authenticating code comprises:
establishing a communications link between said first transaction processor and a computer coupled to said printer;
maintaining said communications link open between said first transaction processor and said computer until said second authenticating code is printed on said printable media;
confirming to the first transaction processor that said second authenticating code actually printed on said printable media;
linking by the first transaction processor of the first and second authenticating codes in a database of valid authenticating codes; and,
closing said communications link between said computer and said first transaction processor.

16. A method of generating a secure document comprising:
reading a first authenticating code from a printable media positioned within the paper feed path of a printing platform;
communicating said first authenticating code to a computer;
communicating said first authenticating code from said computer to a first transaction processor;
issuing a second authenticating code by said first transaction processor;
linking said first and second authenticating codes in a database of valid authenticating codes;
transmitting said second authenticating code from said first transaction processor to said computer; and,
printing said second authenticating code on said printable media.

17. A method of generating a secure document according to claim 16, comprising:
reading said first authenticating code using a first reader coupled to a second transaction processor;
reading said second authenticating code using a second reader coupled to said second transaction processor;
transmitting said first and second authenticating codes from said second transaction processor to a third transaction processor;
comparing said first and second authenticating codes against valid codes stored in said database of valid authenticating codes;
transmitting a first message from said third transaction processor to said second transaction processor if said first and second authenticating codes are found in said database of valid authenticating codes; and,
transmitting a second message from said third transaction processor to said second transaction processor if said first and second authenticating codes are not found in said database of valid authenticating codes.

18. A system for generating a secure document using a printable media having a first authenticating code integral therewith, said system comprising:
a printer suitable to print upon said printable media;
a detector adapted to read said first authenticating code; and,
a first transaction processor arranged to store said first authenticating code read by said detector, and provide a second authenticating code, wherein said printer is arranged to print said second authenticating code onto said printable media.

19. A system for generating a secure document according to claim 18, wherein said first authenticating code is a unique code programmed into an radio frequency identification device.

20. A system for generating a secure document according to claim 19, wherein said radio frequency identification device is embedded within said printable media.

21. A system for generating a secure document according to claim 18, wherein said first authenticating code comprises an invisible ink printed upon said printable media.

22. A system for generating a secure document according to claim 18, wherein said first authenticating code comprises a unique code selected from the group consisting of a printed code of ferrous ink, a magnetic strip, and an encrypted bar code.

23. A system for generating a secure document according to claim 18, wherein said detector is incorporated into said printer.

24. A system for generating a secure document according to claim 18, wherein said detector is a separate unit attached to said printer.

25. A system for generating a secure document according to claim 18, wherein said detector is attached to said printer along a paper feed path of said printer.

26. A system for generating a secure document according to claim 18, wherein said detector comprises a hand-held reader.

27. A system for generating a secure document according to claim 18, further comprising a computer coupled to said printer and said detector, said computer arranged to communicate with said first transaction processor and with said detector.

28. A system for generating a secure document according to claim 27, wherein said computer communicates with said first transaction processor over a network connection.

29. A system for generating a secure document according to claim 28, wherein said network connection comprises an Internet connection, and said first transaction processor comprises an Internet enabled software program.

30. A system for generating a secure document according to claim 27, further comprising a software program installed on said computer adapted to communicate with said detector and said first transaction processor.

31. A system for generating a secure document according to claim 30, wherein said software program comprises a printer driver.

32. A system for generating a secure document according to claim 27, wherein said computer comprises a general purpose computer.

33. A system for generating a secure document according to claim 27, wherein said computer comprises a processor built into said detector.

34. A system for generating a secure document according to claim 18, further comprising a second transaction processor, said second transaction processor comprising:
a first reader;
a second reader; and,
a communication device, wherein said first reader is arranged to read said first authenticating code of said secure document, said second reader is arranged to read said second authenticating code, and said communication device is arranged to communicate said first and second authenticating codes to a third transaction processor to validate said secure document.

35. A system for generating a secure document according to claim 34, wherein said first and third transaction processors are implemented on the same hardware.

36. A system for generating a secure document according to claim 18, wherein said second authenticating code comprises bar code indicia.

37. A system for creating a secure document comprising:
a radio frequency identification device embedded within a printable media, said radio frequency identification device programmed to store a unique first authenticating code;
a detector comprising a radio frequency device reader integrated into a paper feed path of a printing platform;
a computer arranged to communicate with said detector and said printing platform; and,
a first transaction processor arranged to receive said first authenticating code read by said detector and issue a bar code comprising a second authenticating code against said first authenticating code, wherein said second authenticating code is printed onto said printable media by said printing platform.
